(19) United States
(12) Patent Application Publication
(10) Pub. No.: US 2009/0212224 A1
(43) Pub. Date: Aug. 27, 2009

(54) Nuclear imaging scanner with event position-identifying accelerometers

(76) Inventor: James Mark Long, Knoxville, TN (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/070,751

(22) Filed: Feb. 21, 2008

(51) Int. Cl. G01T 1/20; G01T 1/164

(52) U.S. Cl. 250/363.02; 250/362

(57) ABSTRACT

A nuclear medical imaging system has one or more detector units arranged around or that can be swept around a patient bed. Each of the detector units includes an angular orientation-sensing accelerometer. By determining angular orientation of the detector from signals outputted by the accelerometer, the circumferential position of the detector relative to the patient bed can be determined. That information is used in conjunction with information about detected events to construct an image of an organ or tissue mass of interest.

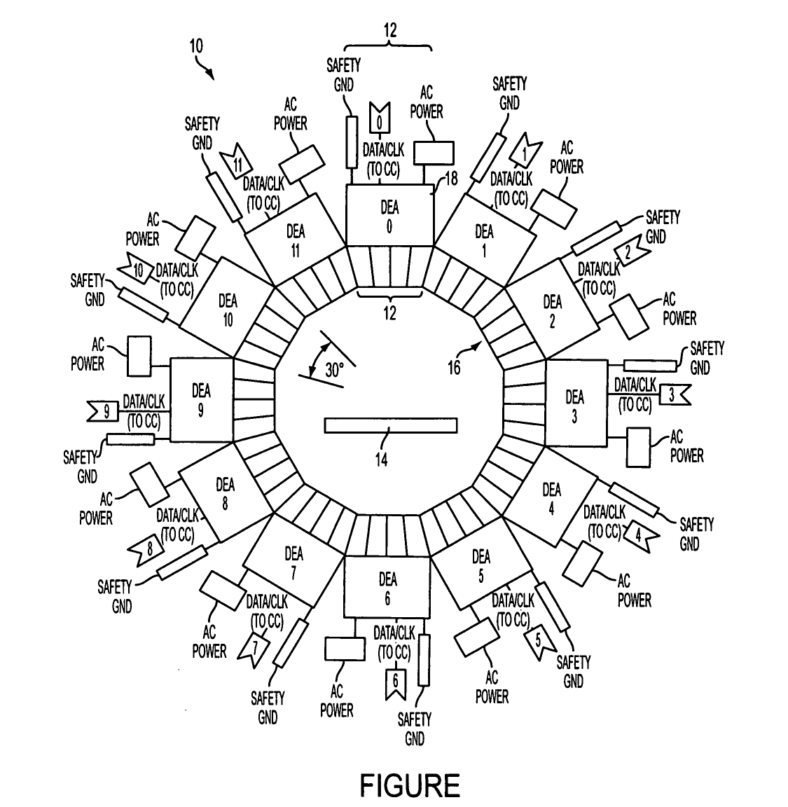

### TECHNICAL FIELD

The current invention is in the field of nuclear medical imaging. Particularly, the invention relates to imaging scanners and means by which detected events can be localized.

### BACKGROUND OF THE INVENTION

In PET imaging, for example, positrons are emitted from a radiopharmaceutically doped organ or tissue mass of interest. The positrons combine with electrons and are annihilated and, in general, two gamma photons which travel in diametrically opposite directions are generated simultaneously upon that annihilation. Opposing crystal detectors, which each scintillate upon being struck by a gamma photon, are used to detect the emitted gamma photons. By identifying the location of each of two essentially simultaneous gamma interactions as evidenced by two essentially simultaneous gamma emissions from a positron annihilation event, a line in space along which the two gamma photons have traveled (a “line of response,” or “LOR”) can be determined, from which the location of the original positron annihilation event can be calculated. The LORs associated with many million annihilation events with the detectors are calculated and “composited” to generate an image of the organ or tissue mass of interest, as is known in the art.

Conventionally, an array of PET crystal detectors may be arranged circumferentially all the way around a bed on which the patient lies during the scan, with the bed oriented horizontally and the “ring” of detectors oriented in a vertical plane with the bed extending axially through the center of the ring. In such a case, with detectors completely surrounding the patient bed, the detectors remain stationary. (The bed may move longitudinally to image different regions of interest of the patient's body.) However, even though the detectors remain stationary, it is still necessary to know the position in space of each detector so that the LORs can be constructed by digitally “tagging” or identifying each PET interaction event with its associated position. In general, that detector position can be determined if the angular orientation in space of the detector is known, since each detector around the ring of detectors will have a unique angular orientation. Current schemes set in hardware—usually by use of DIP switches—the circumferential position of each of the acquiring detector's electronics, thereby providing a basis by means of which individual detector pixels may be encoded. DIP switches, however, may require manual setting and therefore can be easily set to an incorrect setting.

Other PET imaging systems, on the other hand, use fewer detectors, and the detectors do not completely encircle the patient bed. For example, PET systems are known which use just two opposing detectors that are supported by a gantry, and the detectors are rotated by the gantry, e.g., through 180° each, so as to acquire a full 360° sweep of the patient. Other types of imaging systems such as SPECT imaging systems, as well as others, may use even less detectors, i.e., a single detector, and also acquire a fully swept image by rotating the detector around the patient, e.g., through a full 360°.

These non-fully-encircling systems (PET, SPECT, and others) also rely on knowing the position of the detector in space in order to construct LORs or otherwise generate an image of the patient. In such rotating systems, the detector position in space is typically determined by determining the rotational position of the gantry, which requires geared linkages and/or encoders. “Play” between system components can, however, cause inaccuracies in the detector positions determined by such means.

Accordingly, improved instrumentalities for determining the position of nuclear imaging detector(s) is desirable.

### SUMMARY OF THE INVENTION

According to the invention, a nuclear medical imaging system has one or more detector units arranged around or that can be swept around a patient bed. Each of the detector units includes an angular orientation-sensing accelerometer. By determining angular orientation of the detector, the circumferential position of the detector relative to the patient bed can be determined. That information is used in conjunction with information about detected events to construct an image of an organ or tissue mass of interest.

In particular, according to one aspect of the invention, a nuclear medical imaging system is provided, which includes at least one detector unit that is sensitive to radiation emitted by a radiopharmaceutically doped organ or tissue mass of interest; and an angular orientation-sensing member mounted on the detector unit.

According to another aspect of the invention, a method of encoding scintillation events detected by a radiation detector includes providing an angular orientation value from an angular orientation member associated with the radiation detector, associating the angular orientation value with information concerning a detected scintillation event from the radiation detector, and transmitting the associated information to a processor.

### BRIEF DESCRIPTION OF THE DRAWING

The invention will now be described in greater detail in connection with the DRAWING, in which:

the FIGURE is a schematic view of a completely encircling PET detector employing angular orientation accelerometers according to the invention.

### DETAILED DESCRIPTION OF THE INVENTION

A PET detector system 10 according to one embodiment of the invention is illustrated schematically in the FIGURE. The system 10 is of the type described above in which a ring of detector units 12 encircle a patient bed 14. For example, as illustrated, twelve detector units 12 (identified as 0 through 11) may be provided, with each detector unit 12 having a 30° field of view. As is known in the art, each detector unit 12 may include a pixelated detector crystal and may, depending on the specific construction of the unit 12, include a set of photomultiplier tubes or other photosensors. The detector crystals (and photomultiplier tubes) are designated generally (and collectively) by reference numeral 16.

As further illustrated in the FIGURE, each detector unit 12 includes a direct-encoding, DC accelerometer 18 (DEA) (broadly referred to as an angular orientation-sensing member). Such accelerometers are generally known in the field and typically include a pair of orthogonally arranged sensing elements by means of which the angle of inclination of the accelerometer relative to Earth's gravitational field can be determined. Thus, by measuring the angle of inclination of the detector unit 12, the location of the detector unit 12 can be determined, and that location information can be tagged to each event detected by the detector unit, for which the information concerning the detector unit is sent to the imaging system processing computer (not illustrated).

For example, the top detector unit 12 (identified as the 0 detector unit in the FIGURE) has a detector orientation of 180° (facing straight down); thus, any detected event that occurs at the topmost detector unit 0 is tagged with an orientation of 180°. Similarly, for a twelve-unit system as shown, the next detector unit 12 in the clockwise direction (identified as 1 in the FIGURE) will have an orientation of 210°; the next detector unit 2 will have an orientation of 240°; and so on around the detector system. Thus, the detected events from all detector units 12 can be compiled along with the associated detector orientations, and the LORs can be generated by pairing essentially simultaneous events that have associated detector orientations that are 180° apart from each other.

In an alternative arrangement (not illustrated), only one or two detector units are provided, which do not completely encircle the patient bed but which are swept around the patient as described above. The detector(s) in such an arrangement would also include an orientation-sensing accelerometer, by means of which the position in space of the detector can be determined and hence the angular location of the detector. As above, with such a system (particularly a PET system with two opposing detector units), all detected events can be compiled and paired based on opposing detector locations, together with the actual angular orientation of the opposing detectors in space.

In addition to event encoding, the accelerometer-provided detector location may be used as detector address information for addressed bus communications for various purposes such as to provide setup information, collect statistical information, etc.

The invention having been thus described, it will apparent to those skilled in the art that the same may be varied in many ways without departing from the spirit and scope of the invention. For example, other imaging technologies besides PET and SPECT may benefit from the invention. Any and all such modifications are intended to be included within the scope of the following claims.

What is claimed is:

1. A nuclear medical imaging system, comprising:
at least one detector unit that is sensitive to radiation emitted by a radiopharmaceutically doped organ or tissue mass of interest; and
an angular orientation-sensing member mounted on the detector unit.

2. The imaging system of claim 1, wherein said imaging system comprises a plurality of detector units and each of said detector units has an angular orientation sensing member mounted thereon.

3. The imaging system of claim 2, further including a patient bed, wherein said plurality of detector units form a full circle around said patient bed.

4. The imaging system of claim 1, wherein said angular orientation-sensing member comprises an accelerometer.

5. The imaging system of claim 4, wherein said accelerometer is a DC accelerometer.

6. The imaging system of claim 1, wherein said imaging system is a PET imaging system.

7. The imaging system of claim 1, wherein said imaging system is a SPECT imaging system.

8. The imaging system of claim 1, wherein said angular orientation-sensing member provides angular position information for radiation events detected by said detector unit.

9. The imaging system of claim 1, wherein said angular orientation-sensing member provides address information for communications of a processing unit of said system with said detector unit.

10. A method of encoding scintillation events detected by a radiation detector, comprising:
providing an angular orientation value from an angular orientation member associated with said radiation detector;
associating said angular orientation value with information concerning a detected scintillation event from said radiation detector; and
transmitting said associated information to a processor.

11. The method of claim 10, wherein said radiation detector is a component of a PET imaging system.

12. The method of claim 10, wherein said radiation detector is a component of a SPECT imaging system.

13. The method of claim 10, wherein said angular orientation member is an accelerometer.

14. The method of claim 13, wherein said accelerometer is a DC accelerometer.
